(19) United States
(12) Patent Application Publication
(10) Pub. No.: US 2002/0117477 A1
(43) Pub. Date: Aug. 29, 2002

(54) Modular arc chamber assembly

(76) Inventors: Gary Steven Douville, East Hartford, CT (US); David Alan Barkus, Oakville, CT (US); Jason Edward Harmon, Bristol, CT (US)

Correspondence Address: PATENT OPERATION, GENERAL ELECTRIC COMPANY, 41 WOODFORD AVENUE, PLAINVILLE, CT, 06062

(21) Appl. No.: 09/794,555

(22) Filed: Feb. 27, 2001

(51) Int. Cl. H01H 33/02

(52) U.S. Cl. 218/156

(57) ABSTRACT

A modular arc chamber assembly suitable for use in a cassette assembly in a circuit breaker comprising: an electrically insulative first side member, an electrically insulative second side member; a plurality of plates disposed between said first and second side members and arranged in a stacked spaced-apart relationship, and an arc runner plate disposed at one end and between the first and second side members capable of directing an arc to an arc dissipating chute comprised of the plurality of arc plates.

### BACKGROUND OF THE INVENTION

The present invention relates to an arc chamber, and more particularly, to a modular arc chamber assembly for a circuit breaker.

Circuit breakers are one of a variety of overcurrent protective devices used for circuit protection and isolation. The basic function of a circuit breaker is to provide electrical system protection whenever an electrical abnormality occurs in any part of the system. In a circuit breaker, current enters the system from a power line. The current passes through a strap to a stationary contact fixed on the strap and then to a movable contact. The movable contact is fixedly attached to an arm, and the arm is mounted to a rotor. As long as the stationary and movable contacts are in physical contact, current passes from the stationary contact to the movable contact and out of the circuit breaker to downline electrical devices.

In the event of an overcurrent condition (e.g., a short circuit), extremely high electromagnetic forces are generated. These electromagnetic forces repel the movable contact away from the stationary contact. Because the movable contact is fixedly attached to a rotating arm, the arm pivots and physically separates the stationary and movable contacts thus blowing open (tripping) the circuit. Upon separation of the contacts and blowing open the circuit, an arcing condition occurs. It is desirable to suppress the resultant arc in order to minimize the energy that the breaker sees, thus minimizing breaker damage. The typical method of suppressing the arc is to direct it into an arc chute, which is generally a series of metal plates that dissipate the energy of the arc. This arc chute is situated proximate to the stationary contact point of the circuit.

Such arc chute assemblies consist of a plurality of metallic chute plates that are held in a stacked, spaced-apart relationship by side panels that are fabricated from electrically non-conductive material. Retention of the chute plates between the side panels is usually achieved by providing the plates with small protrusions that are slipped into a series of radiused notches in the side panels.

An arc runner is used to direct the arc to the arc chute. The arc runner substantially covers the exposed area of the stationary contact disposed on the strap. Blowing a circuit open thus resulting in an arc causes tremendous stress to the parts of the system. Since the arc runner provides a pathway for the arc to follow to the arc chute, it is subject to intensely high temperatures. The construction of an arc runner, and especially its manner of securement to the strap, is critical to reliable dissipation of an arc.

Conventional methods of securing an arc runner to a load or line strap increase the costs of manufacturing a circuit breaker because of the hardware involved. The arc runner is typically screwed onto the strap, as described in U.S. Pat. No. 5,877,467 entitled “Circuit Breaker Current Limiting Arc Runner”. Similarly, U.S. Pat. No. 5,075,520 entitled “Contact Member for Electrical Switching Devices” describes an arc runner having one end inserted into a groove in a block and then having the arc runner secured to the block by a screw. The use of a screw in the fastening operation adds the cost of an extra piece of hardware to the manufacturing process.

Bolts are also used to secure an arc runner to a strap. For example, U.S. Pat. No. 4,229,630 entitled “Circuit Breaker Utilizing Improved Arc Chambers” describes using a pair of bolts that extend through openings in an arc runner to secure the arc runner to a stationary contact. Another method of securing an arc runner to a strap includes the use of rivets, as discussed in U.S. Pat. No. 4,771,140 entitled “Circuit Interrupter”, wherein a single rivet pierces the body of an arc runner and a stationary conductor to firmly connect the arc runner to the stationary conductor. Bolts and rivets add the cost of an extra piece of hardware to the manufacturing process in the same way that screws do.

Brazing, or Welding, as discussed in U.S. Pat. No. 5,818,003 entitled “Electric Switch with Arc Chute, Radially Converging Arc Splitter Plates, and Movable and Stationary Arc Runners”, provides a further option for securing an arc runner to a strap, wherein the strap is directly welded to a D-shaped arc runner. Although brazing and welding do not introduce an additional discrete component into the manufacturing process, they do contribute to the expenses associated with the finished product.

In most conventional circuit breaker designs, a lower arc runner is brazed to the fixed contact strap and a top arc runner is snapped into the cassette molding. The disadvantage of this design is that the upper arc runner could conceivably be installed improperly or forgotten entirely. Also, as mentioned, brazing the lower arc runner to the fixed contact strap adds manufacturing costs and complexity.

In addition to the costs of the hardware used to fasten the arc runner to the strap, tools are required. Automated assembly systems and automated welders are usually expensive to install and run. Furthermore, the maintenance for these systems is costly, and the use of such systems often poses reliability concerns. Hand-held tools such as wrenches and screwdrivers, on the other hand, are far less expensive. The use of small hand-held tools may, however, increase the time required for assembly of an arc runner to a load strap because machine assembly is usually faster than hand assembly is. An increase in the time required for assembly using hand-held tools is becoming cost prohibitive. Furthermore, hand-held tools, because of their size, frequently tend to be misplaced and need to be replaced on a regular basis. Constant replacement of even the most inexpensive tools can be a limiting factor.

Circuit breaker design, and more particularly, cassette design should enable the efficient and proper positioning of the various components, such as the rotor and arc chute assemblies, into the cassette. For example, care must be taken to ensure that an arc chute assembly is correctly positioned into the cassette. This ensures proper rotation of the moveable contact arm as well as the proper spacing between the moveable contact and the plate closest to the moveable contact. Improper installation of an arc chute assembly into a cassette half piece will require disassembly and reassembly of the cassette. Such disassembly and reassembly is time consuming and can increase the production cost of the circuit breaker.

### BRIEF SUMMARY OF THE INVENTION

The above discussed and other drawbacks and deficiencies are overcome or alleviated by a modular arc chamber assembly suitable for use in a cassette assembly in a circuit breaker comprising: an electrically insulative first side member, an electrically insulative second side member; a plurality of plates disposed between said first and second side members and arranged in a stacked spaced-apart relationship, and an arc runner plate disposed at one end and between the first and second side members capable of directing an arc to an arc dissipating chute comprised of the plurality of arc plates.

The above-discussed and other features and advantages of the present disclosure will be appreciated and understood by those skilled in the art from the following detailed description and drawings.

### BRIEF DESCRIPTION OF THE DRAWINGS

Referring to the exemplary drawings wherein like elements are numbered alike in the several Figures:

FIG. 1 is a front perspective view of a circuit breaker rotary cassette assembly;

FIG. 2 is a front perspective view of a first electrically insulative cassette half piece of the cassette assembly;

FIG. 3 is a view of a first electrically insulative cassette half piece of the cassette assembly showing the arc chamber recesses and retention features;

FIG. 4 is a view of a second electrically insulative cassette half piece of a cassette assembly showing the arc chamber recesses and retention features;

FIG. 5 is a top view of a preferred embodiment of a modular arc chamber assembly employed in the electrically insulative cassette half pieces of FIGS. 2 and 3;

FIG. 6 is a front perspective view of an arc chamber assembly of FIG. 4 employed in the electrically insulative cassette half pieces of FIGS. 2 and 3;

FIG. 7 is a side view of an arc side member employed in the modular arc chamber assembly of FIG. 4;

FIG. 8 is a front perspective view of a preferred embodiment of a modular arc chamber assembly employed in a cassette assembly; and

FIG. 9 is a view of a preferred embodiment of a modular arc chamber assembly employed in a cassette assembly.

### DETAILED DESCRIPTION OF THE INVENTION

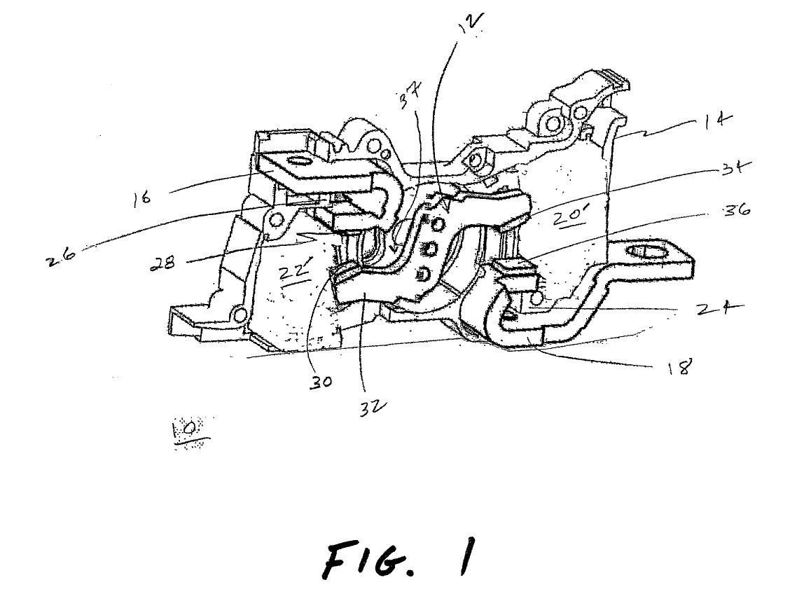

Referring to FIG. 1, a rotary contact assembly 12 in a circuit breaker cassette assembly 10 is shown in a first electrically insulative cassette half piece 14 intermediate a line-side contact strap 16, load-side contact strap 18 and associated arc chambers 20′, 22′. Line-side contact strap 16 is electrically connected to line-side wiring (not shown) in an electrical distribution circuit, and load-side contact strap 18 is electrically connected to load-side wiring (not shown) via a lug (not shown) or some device such as a bimetallic element or current sensor (not shown). Electrically insulative shields 24, 26 separate load-side contact strap 18 and line-side contact strap 16 from the associated arc chamber assemblies 20, 22 respectively. Although a single rotary contact assembly 12 is shown, it is understood that a separate rotary contact assembly 12 is employed within each pole of a multi-pole circuit breaker and operates in a similar manner.

Electrical transport through the circuit breaker interior proceeds from the line-side contact strap 16 to associated first fixed and first moveable contacts 28, 30 at one end of a movable contact arm 32, to second fixed and second movable contacts 34, 36 at the opposite end thereof, to the associated load-side contact strap 18. The movable contact arm 32 is arranged between two halves of a circular rotor 37. Moveable contact arm 32 moves in unison with the rotor 37 upon manual articulation of the circuit breaker operating mechanism (not shown) to drive the first and second movable contacts 30, 36 between CLOSED and OPEN (depicted in FIG. 1) positions.

In an exemplary embodiment, modular arc chamber assemblies 20, 22 are positioned in the first electrically insulative cassette half piece 14 adjacent the respective pairs of first fixed and first moveable contacts 28, 30 and second fixed and second moveable contacts 34, 36. The first and second movable contacts 30, 36 and moveable contact arm 32 move through a passageway provided by arc plates intermediately disposed on modular arc chamber assemblies (not shown) 20, 22 in order to engage and disengage the respective first and second fixed contacts 28, 34. Each modular arc chamber assembly 20, 22 is adapted to interrupt and extinguish the arc which forms when a circuit breaker is tripped and the first and second moveable contacts 30, 36 are suddenly separated from the first and second fixed contacts 28, 34.

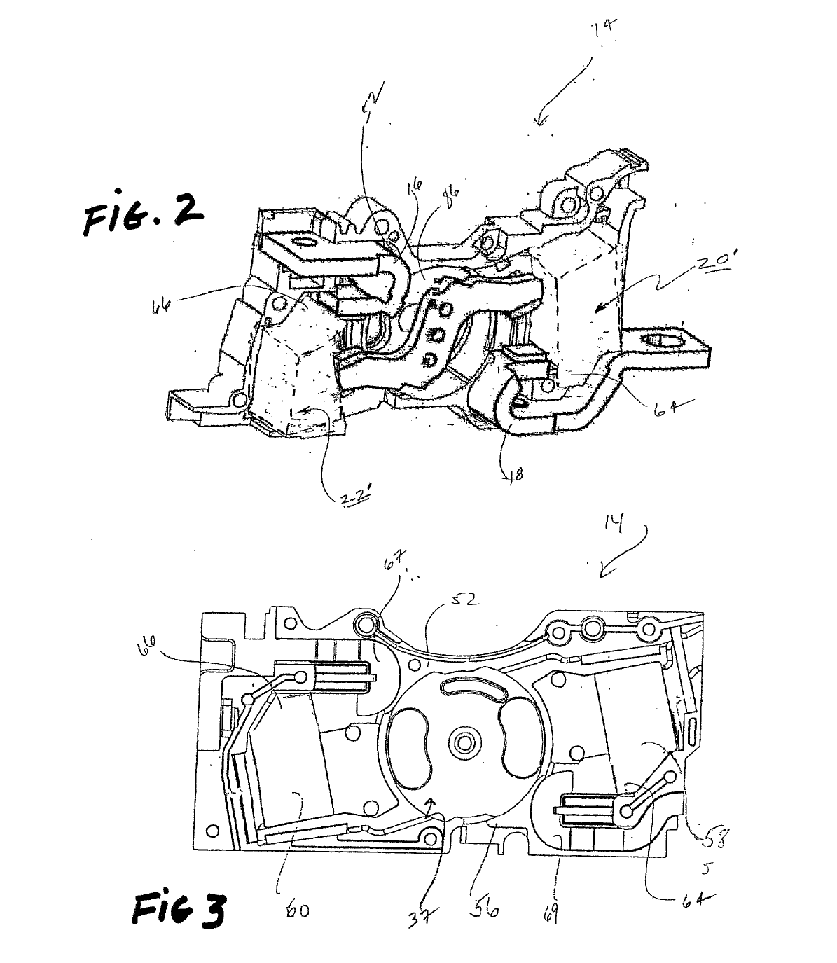

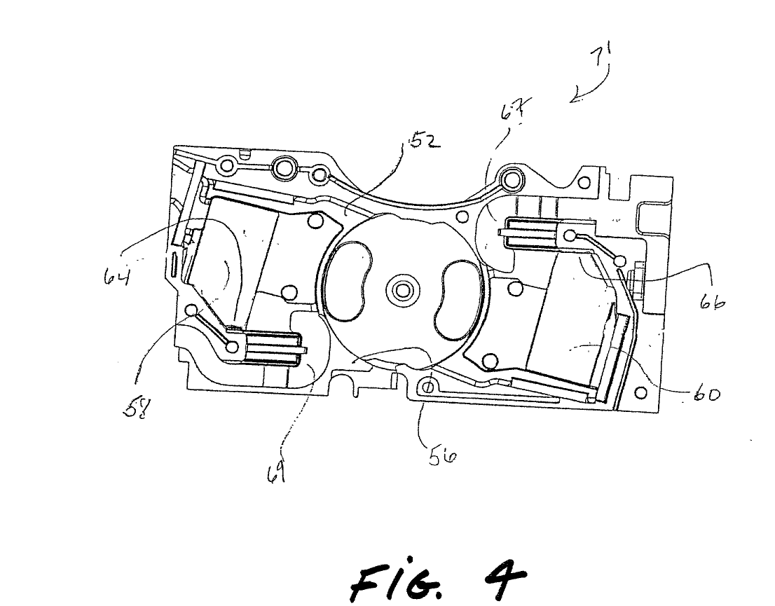

Referring to FIGS. 2 and 3, the first electrically insulative cassette half piece 14 is shown. First electrically insulative cassette half piece 14 has an inner surface 52 having a rotor recess 56 also formed on the inner surface 52. Arc chambers 20′, 22′ (shown in phantom) are disposed on either side of the rotor recess 56. FIG. 3 shows load-side and line-side contact strap recesses 67, 69 that are also formed on the inner surface 52 proximate arc chamber recesses 58, 60. Arc chamber recesses 58, 60 are substantially rectangular with each having defined complementary pockets (e.g., recesses) 64, 66 respectively to more clearly define a recessed pocket in which to position a modular arc chamber assembly 20, 22. It should also be noted that defined complementary pockets 64, 66 are positioned and oriented to the load-side and line-side contact strap recesses 67, 69.

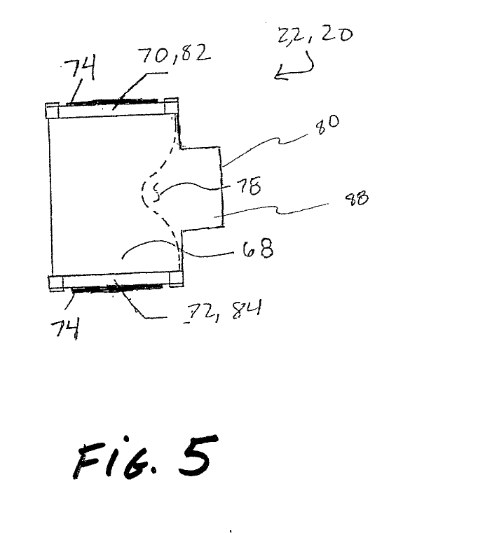

Referring to FIG. 4, a second electrically insulative cassette half piece 71 is shown prior to attaching with the first electrically insulative cassette half piece 14 (FIG. 3) to form a complete enclosure. Second electrically insulative cassette half piece 71 has an inner surface 52. Second electrically insulative cassette half piece 71 is attached to the first electrically insulative cassette half piece 14 (FIG. 3) by suitable mechanical fastening means. A rotor recess 56 is also formed on the inner surface 52. Load-side and line-side contact strap recesses 67, 69 are also formed on the inner surface 52 proximate the arc chamber recesses 58, 60 clearly defining a pocket in which to position a modular arc chamber assembly. It should be noted that a pocket is clearly defined with defined complementary pockets 64, 66 as part of the arc chamber recesses 58, 60.

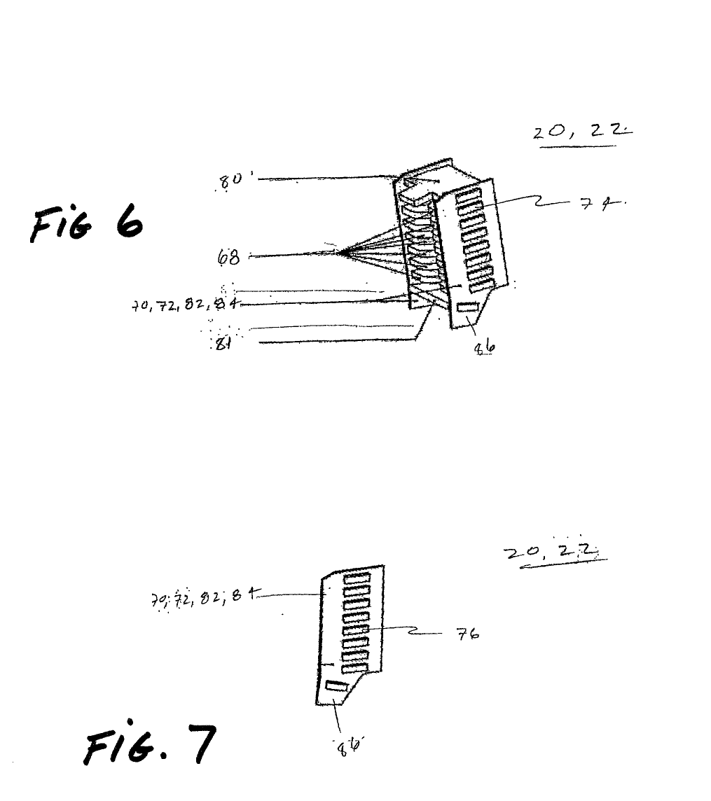

Referring to FIGS. 5 and 6, a modular arc chamber assembly 22 for a circuit breaker is shown. The modular arc chamber assembly 22 includes a plurality of plates 68 (drawn in phantom lines in FIG. 5), a first side member 70 and a second side member 72. The plurality of plates 68 are intermediate a first arc runner plate 80 at one end and a second arc runner plate 81 at the other end. The first arc runner plate 80 further includes a tab 88 extending and angled therefrom to facilitate guiding an arc into the chamber 22′. Typically, the plates 68 are metallic so as to induce magnetism thereby promoting arc movement into arc chamber assembly 22. Each plate 68 and each arc runner plate 80, 81 have a protrusion 74 extending from each side thereof for coupling each plate 68 and each runner plate 80, 81 to side members 70, 72, via an interference fit. Each plate 68 also includes a radiused notch 78 formed on one side thereof. The radiused notch 78 provides clearance for the contact arm 32 when the arc chute assembly 22 is mounted within the electrically insulative cassette half pieces 14, 71 (FIGS. 2 and 3). An exemplary embodiment includes a first arc runner plate 80 at one end of a modular arc chamber assembly and a second arc runner plate 81 at the other end that does not extend beyond side members 70, 82 (FIG. 6) of the modular arc chamber assembly second arc runner plate 81 and is in close proximity with either a load-side or a line-side contact strap 16, 18. Arc runner plate 80 further includes a tab extending therefrom and angled to facilitate guidance of an arc into arc chamber assembly 22.

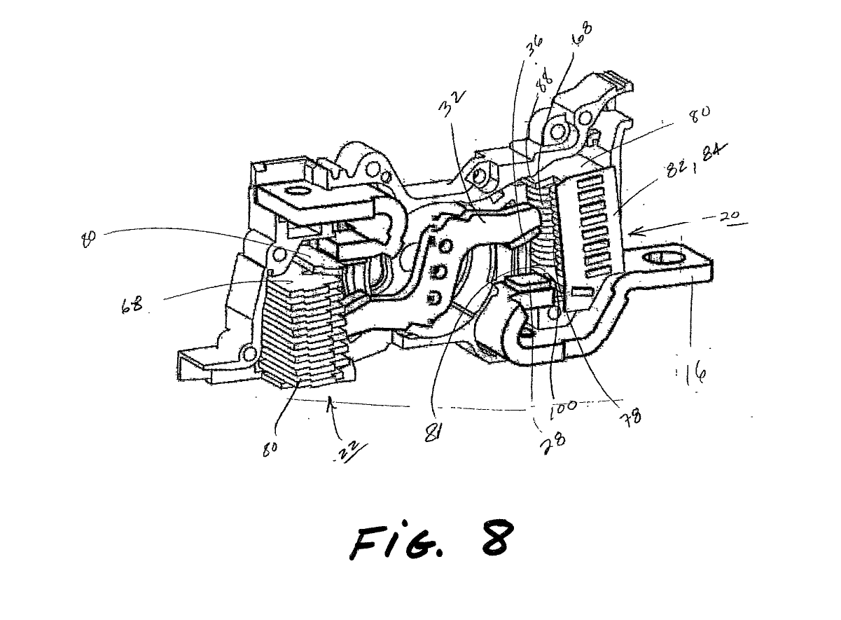

Referring to FIGS. 6 and 7, first and second side members 70, 72 have a plurality of slots 76 formed therethrough. Each protrusion 74 of the plates 68 and the runner plates 80, 81 are respectively inserted into a corresponding slot 76 formed in the first and second side members 70, 72. The plates 68 are disposed in this manner between the first and second side members 70, 72 and are arranged in a stacked, spaced-apart relationship to each other. Second side member 72 is identical to first side member 70. The first and second side members 70, 72 are assembled so as to be opposedly oriented to each other. First side member 70 has a defined portion (i.e., a protruding tab) 86 offsetly located and proximate arc runner plate 81 to facilitate assembly of an arc chamber assembly 22 into an arc chamber 22′. A defined portion 86 is similarly located along second side member 72.

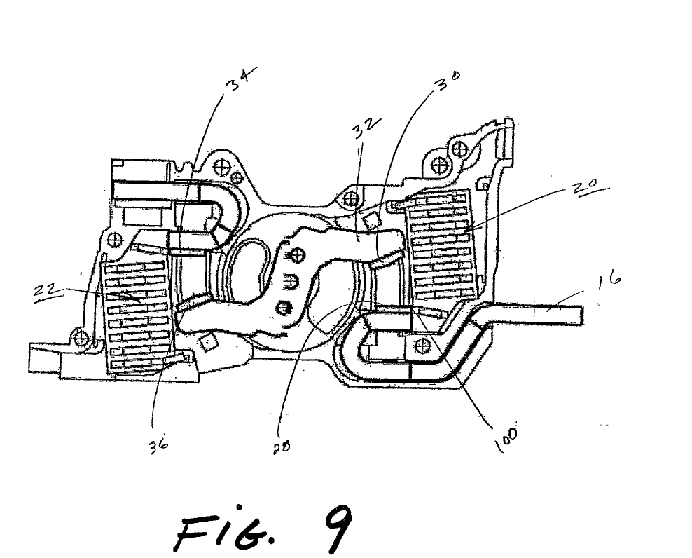

Turning to FIG. 8, a second arc chamber assembly 20 comprises a plurality of plates 68 and third and fourth side members 82, 84. Third and fourth side members 82, 84 are identical to first and second side members 70, 72. Third and fourth side members 82, 84 are assembled so as to be opposedly oriented to each other. Third side member 82 has a defined portion 86 offsetly located and proximate to arc runner plate 81. A defined portion 86 is similarly located along the fourth side member 84. In an exemplary embodiment, a modular arc chamber assembly comprises two arc runner plates 80, 81 having arc runner plate 81 near the contact 28 making in close proximity with an edge of contact 28 and an edge of the first arc runner plate 81. Arc runner plate 80 is disposed at an opposite end substantially parallel to plates 68 within the assembly 20 and further includes a tab 88 extending towards contact 36 to help direct an arc into assembly 20 to dissipate when circuit breaker 10 is in the OPEN position. Modular arc chamber assembly 22 would be similarly constructed.

Referring to FIGS. 2, 3, 4 and 9, the first modular arc chamber assembly 22 is correctly positioned into the first electrically insulative cassette half piece 14 by orienting and placing defined portion 86 of the first side member 70 into the first recess 60 having offset extension 66 of first electrically insulative cassette half piece 14. Similarly, the second modular arc chamber assembly 20 is correctly positioned into the first electrically insulative cassette half piece 14 by orienting and placing defined portion 86 to fit into the second recess 58 having defined portion 86 of first electrically insulative cassette half piece 14. It should be noted that the defined portion 86 provides only one orientation of the arc chamber assembly in order to fit within the recesses 58, 60 of cassette.

An alternative embodiment is absent any defined portions 86 and defined complementary pockets 64, 66 to correctly position the arc chamber assemblies 22, 20. It should be noted that if a cassette assembly does not include defined portions 86 and defined complementary pockets 64, 66 to facilitate positioning the arc chamber assemblies 22, 20 for example, then the radiused notches 78 (shown in FIGS. 5 and 8) in the plates 68 might be incorrectly positioned to face opposite the first and second moveable contacts 30, 36 and the first and second fixed 28, 34 contacts. If this were to occur, the moveable contact arm 32 would not be permitted to rotate when the circuit breaker is tripped due to a short circuit event. Also, the arc chamber assembly 22 could be placed upside down with respect to the first electrically insulative cassette half piece 14. If this were to occur, there can be insufficient air space between the plate 68 that is closest to the first moveable contact 30 and the line-side contact strap 16. The loss of a conducting plate in the arc chute assembly 22 can result in an insufficient arc quenching. Thus, defined portions 86 ensure the correct positioning of the arc chamber assemblies 22, 20 within the recesses 58, 60. Furthermore, the inner surface 52 of an electrically insulative cassette half piece in a preferred embodiment includes a groove for top runner and) recesses formed therein for proper positioning.

Referring now to FIGS. 2, 3, 4, 5, 6 and 7, after the first and second arc chamber assemblies 22, 20 are properly assembled into the first electrically insulative cassette half piece 14, the second electrically insulative cassette half piece 71 is placed over the first electrically insulative cassette half piece 14 to form a complete enclosure. As a result, defined portion 86 of the second side member 72 will be inserted into a third recess 64 of the second electrically insulative cassette half piece 60. Defined portion 86 of the fourth side member 84 will likewise be inserted into the fourth recess 66 of the second electrically insulative cassette half piece 71. Thus, the first and second arc chamber assemblies 22, 20 will be correctly positioned into the first and second electrically insulative cassette half pieces 14, 71. Proper operation of the rotary contact arm assembly is achieved.

The first, second, third and fourth side members 70, 72, 82, 84 have been heretofore described with defined portions 86 that are offsetly located. The advantage to this arrangement of the defined portion 86 along the respective ends of the side members 70, 72, 82, 84 is the cost savings attributed to forming one stamped pattern that can be used for all side members 70, 72, 82, 84 for both the first and second arc chamber assemblies 22, 20.

Since the first and second arc chamber assemblies 22, 20 are assembled prior to placement within the first electrically insulative cassette half piece 14, correct positioning of the first and second arc chamber assemblies 22, 20 can also be achieved by using defined portions 86 on only the first and third side members 70, 82. In this alternative embodiment, the second and fourth side members 72, 84 would have no defined portions 86. However, this would require the manufacture of two structurally different side members. Further, defined portions 86 on the first and third side members 70, 82, as well as second and fourth side members 72, 84, can be located generally central as opposed to located offset along the edges of the respective side members. However, this would require additional time to consider the orientation of the notches 78 respective to the contact arm location and the manufacture of a third type of side member to accommodate the defined center portion arrangement.

As described herein, a cassette assembly for rotary contact circuit breakers utilizing a first electrically insulative cassette half piece 14 and a second electrically insulative cassette half piece 71 are arranged to mate with each other to form an enclosure. The electrically insulative cassette half pieces 14, 71 include improper installation rejection features for the arc chamber assemblies 22, 20. Therefore, the cassette assembly, as described herein, prevents such disassembly and reassembly that can be time consuming and increase the production cost of the circuit breaker. Furthermore, by incorporating at least one runner plate with an arc chute assembly, a brazing or welding step may be eliminated, or alternatively, a runner is less likely not to be installed, thereby reducing manufacturing costs and complexity.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but rather that the invention will include all embodiments falling within the scope of the appended claims.

What is claimed is:

1. A modular arc chamber assembly suitable for use in a cassette assembly in a circuit breaker comprising:
an electrically insulative first side member,
an electrically insulative second side member,
a plurality of plates disposed between said first and second side members and arranged in a stacked spaced-apart relationship, and
an arc runner plate disposed between said first and second side members and arranged at one end of said plurality of plates.

2. The modular arc chamber assembly in claim 1 wherein said arc runner plate is substantially parallel to said plurality of plates and further comprises a tab extending therefrom.

3. The modular arc chamber assembly in claim 1 further comprising a second arc runner plate disposed between said first and second side members and arranged at another end of said plurality of plates; said second arc runner plate positioned in close proximity with a stationary contact of the circuit breaker.

4. The modular arc chamber assembly in claim 1 further comprising a defined portion in at least one side member for positioning said side member in a complementary pocket of the cassette assembly.

5. The modular arc chamber assembly in claim 1 wherein said first and second side members include a plurality of slots formed therethrough and each of said plurality of plates respectively include a protrusion extending from each side thereof, said protrusions extend through said slots in said first and second side members for an interference fit.

6. A modular arc chamber assembly suitable for use in a cassette assembly in a circuit breaker comprising:
an electrically insulative first side member wherein said first side member includes an upper end and a lower end,
an electrically insulative second side member wherein said second side member includes an upper end and a lower end,
a defined portion in at least one side member for positioning said side member in a complementary pocket of the cassette assembly;
a plurality of plates disposed between said first and second side members and arranged in a stacked spaced-apart relationship,
a first arc runner plate disposed between said first and second side members at said upper end substantially parallel to said plurality of plates, said first runner plate having a tab angled and extending therefrom; and
a second arc runner plate disposed between said first and second side members at said lower end wherein said second arc runner plate is in close proximity with a stationary contact of said circuit breaker.

7. A cassette assembly suitable for use in a circuit breaker comprising:
a first electrically insulative cassette half piece having an inner surface, said inner surface having a first recess formed therein;
a second electrically-insulative cassette half piece having an inner surface, said second electrically insulative cassette half piece arranged for mating with said first electrically insulative cassette half piece; and,
a first arc chamber assembly arranged between said first and second electrically insulative cassette half pieces, said first arc chamber assembly including:
a first side member,
a second side member,
a defined portion in at least one side member for positioning said first side member in a complementary pocket of the cassette assembly,
a plurality of plates disposed between said first and second side members and arranged in a stacked spaced-apart relationship, and
an arc runner plate disposed between said first and second side members and arranged at one end of said plurality of plates.

8. The cassette assembly in claim 7 wherein said arc runner plate is substantially parallel to said plurality of plates and further comprises a tab extending therefrom.

9. The cassette assembly in claim 7 further comprising a second arc runner plate disposed between said first and second side members and arranged at another end of said plurality of plates; said second arc runner plate positioned in close proximity with a stationary contact of the circuit breaker.

10. The cassette assembly in claim 7 wherein said first and second side members include a plurality of slots formed therethrough and each of said plurality of plates respectively include a protrusion extending from each side thereof, said protrusions extend through said slots in said first and second side members for an interference fit.

11. The cassette assembly in claim 7 wherein said inner surface of said second electrically insulative cassette half piece includes a third recess formed therein for positioning said second side member in said second electrically insulative cassette half piece.

12. The cassette assembly in claim 7 further including a second arc chamber assembly arranged between said first and second electrically insulative cassette half pieces, wherein said inner surface of said first electrically insulative cassette half piece includes a second recess formed therein, said second arc chamber assembly including:
a third side member;
a fourth side member;
a defined portion in said third side member for positioning said third side member in a complementary pocket within said second recess of said first electrically insulative cassette half piece,
a plurality of plates disposed between said third and fourth side members and arranged in a stacked spaced-apart relationship, and
an arc runner plate disposed between said third and fourth side members and arranged at one end of said plurality of plates.

13. The cassette assembly in claim 12 wherein said arc runner plate is substantially parallel to said plurality of plates and further comprises a tab extending therefrom.

14. The cassette assembly in claim 12 further comprising a second arc runner plate disposed between said third and forth side members and arranged at another end of said plurality of plates; said second arc runner plate positioned in close proximity with a stationary contact of the circuit breaker.

15. The cassette assembly in claim 12 wherein said third and fourth side members include a plurality of slots formed therethrough and each of said plurality of plates include a protrusion extending from each side thereof, said protrusions extend through said slots in said third and fourth side members for an interference fit.

16. The cassette assembly in claim 12 wherein said inner surface of said second electrically insulative cassette half piece includes a fourth recess formed therein for positioning said fourth side member in said second electrically insulative cassette half piece.

17. A circuit breaker assembly comprising:
a first electrically insulative cassette half piece having an inner surface, said inner surface having a first recess and a second recess formed therein;
a second electrically-insulative cassette half piece having an inner surface, said second electrically insulative cassette half piece arranged for mating with said first electrically insulative cassette half piece;
a first arc chamber assembly arranged between said first and second electrically insulative cassette half pieces, said first arc chamber assembly including:
a first side member,
a second side member,
a defined portion in said first side member for positioning said first side member in a complementary pocket within first recess of said first electrically insulative cassette half piece,
a plurality of plates disposed between said first and second side members and arranged in a stacked spaced-apart relationship,
an arc runner plate disposed between said first and second side members and arranged at one end of said plurality of plates,
a second arc chute assembly arranged between said first and second electrically insulative cassette half pieces, said second arc chute assembly including:
a third side member,
a fourth side member,
a defined portion in said third side member for positioning said third side member in a complementary pocket within said second recess of said first electrically insulative cassette half piece,
a plurality of plates disposed between said third and fourth side members and arranged in a stacked spaced-apart relationship,
an arc runner plate disposed between said third and fourth side members and arranged at one end of said plurality of plates,
a line-side contact strap arranged for connection with an electric circuit, said line-side contact strap including a first fixed contact connected to said line-side contact strap, said first arc chamber assembly proximate said line-side contact strap for quenching arcs,
a load-side contact strap arranged for connecting with associated electrical equipment, said load-side contact strap including a second fixed contact connected to said load-side contact strap, said second arc chamber assembly proximate said load-side contact strap for quenching arcs,
a rotor defining first and second opposing sides thereon, and,
a moveable contact arm intermediate said first and second sides, said moveable contact arm defining a first moveable contact at one end arranged opposite said first fixed contact and a second movable contact at an end opposite said one end arranged proximate said second fixed contact, said rotor and said moveable contact arm being retained intermediate said first and second electrically insulative cassette half pieces.

18. The circuit breaker assembly in claim 17 wherein each arc chamber assembly further comprises a second arc runner plate disposed between said side members and arranged at another end of a first arc runner plate; said second arc runner plate positioned in close proximity with one of said contact straps.
